(19) United States
(12) Patent Application Publication
(10) Pub. No.: US 2026/0332005 A1
(43) Pub. Date: Oct. 22, 2026

(54) SERVO MOTOR POWER SOURCE SYSTEM

(71) Applicant: FANUC CORPORATION, Minamitsuru-gun, Yamanashi (JP)

(72) Inventor: Keitarou INAGAKI, Minamitsuru-gun, Yamanashi (JP)

(73) Assignee: FANUC CORPORATION, Minamitsuru-gun, Yamanashi (JP)

(21) Appl. No.: 18/994,216

(22) PCT Filed: Nov. 1, 2022
(86) PCT No.: PCT/JP2022/040914

§ 371 Date: Jan. 14, 2025

(51) Int. Cl. H02K 11/33

(52) U.S. Cl. CPC H02K 11/33

(57) ABSTRACT

This power source system comprises: a servo amplifier; a power source that switchably outputs voltages of at least two sizes; a servo amplifier control circuit that is connected to the power source and that controls the servo amplifier; a switch that opens and closes an electrical path between the power source and the servo amplifier; a voltage comparison circuit that compares the voltage output by the power source and a threshold value prescribed in advance; and a switch control circuit that controls the opening and closing of the electrical path between the power source and the servo amplifier by the switch according to the comparison result from the voltage comparison circuit.

### TECHNICAL FIELD

The present disclosure relates to a power supply system for a servo motor.

### BACKGROUND ART

A servo amplifier driving a servo motor in a machine such as an industrial robot or a machine tool is provided with a drive power supply supplying electric power for driving the servo motor and a control power supply supplying electric power for a circuit controlling the servo amplifier.

### CITATION LIST

### Patent Literature

[PTL 1] JP 2020-162193A

[PTL 2] JP 2012-135164A

### SUMMARY OF INVENTION

### Technical Problem

A power supply system interrupting energization by a drive power supply when not driving a servo motor in order to secure safety of a machine driven by a servo amplifier while securing energization by a control power supply in order to monitor the state of the servo motor is required.

### Solution to Problem

According to an aspect of the present disclosure, a power supply system includes a servo amplifier, a power supply configured to output voltages of at least two kinds of magnitude in a switchable manner, a servo amplifier control circuit being connected to the power supply and configured to control the servo amplifier, switches configured to open and close an electric circuit between the power supply and the servo amplifier, a voltage comparison circuit configured to compare voltage output by the power supply with a predefined threshold value, and a switch control circuit configured to control opening and closing of an electric circuit between the power supply and the servo amplifier by the switches, based on a comparison result by the voltage comparison circuit.

### BRIEF DESCRIPTION OF DRAWINGS

FIG. 1 is a circuit diagram illustrating a power supply system according to an embodiment of the present disclosure.

FIG. 2 is a circuit diagram illustrating a step-down chopper circuit provided in a servo amplifier control circuit in the power supply system according to the embodiment of the present disclosure.

FIG. 3 is a flowchart illustrating an operation related to opening and closing of a switch in the power supply system according to an embodiment of the present disclosure.

FIG. 4 is a circuit diagram illustrating a power supply system based on a conventional example in which a drive power supply and a control power supply are separately provided.

### DESCRIPTION OF EMBODIMENTS

A power supply system for a servo motor according to an embodiment will be described below with reference to the drawings. It should be noted that the same components or components with similar functions are given the same reference sign in the following description. Then, overlapping description of the components may be omitted. “Connected” herein means being “electrically connected.” A switch being turned “on” means that an electric circuit in which the switch is provided is closed, i.e., by a switch performing an on-operation, an electric circuit in which the switch is provided is connected and enters a closed state. A switch being turned “off” means that an electric circuit in which the switch is provided is open, i.e., by a switch performing an off-operation, an electric circuit in which the switch is provided is interrupted and enters an open state.

### Configuration of Power Supply System According to Embodiment of Present Disclosure

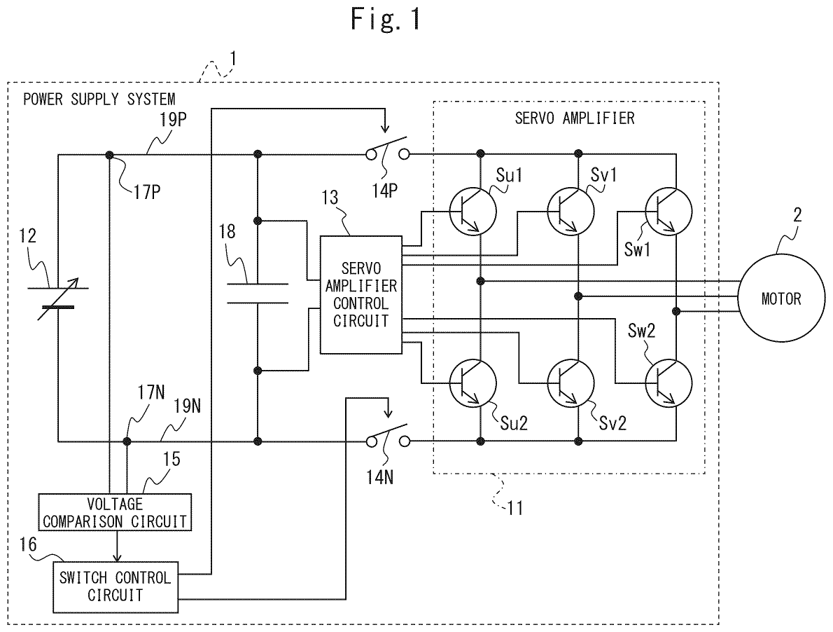

FIG. 1 is a circuit diagram illustrating a power supply system according to an embodiment of the present disclosure.

A case of driving a three-phase motor 2 by electric power supplied from a power supply system 1 will be described as an example. The motor 2 is a servo motor. For example, the motor 2 may be a synchronous motor or an induction motor. Examples of a machine provided with the motor 2 include an industrial robot and a machine tool.

According to a first embodiment of the present disclosure, the power supply system 1 includes a servo amplifier 11, a power supply 12, a servo amplifier control circuit 13, a positive-side switch 14P, a negative-side switch 14N, a voltage comparison circuit 15, a switch control circuit 16, a positive-side potential detection unit 17P, a negative-side potential detection unit 17N, and a capacitor 18.

The power supply 12 outputs direct-current voltages of at least two kinds of magnitude in a switchable manner. Examples of the power supply 12 include a variable voltage source including a battery and an output changeover switch, a variable voltage source including a battery and a variable resistor, and a PWM rectifier converting alternating-current power supplied from an alternating-current power supply into direct-current power and outputting the direct-current power. For example, when the power supply 12 is configured with a PWM rectifier, the power supply 12 includes a bridge circuit including switching elements and diodes respectively connected in antiparallel with the switching elements; and for example, each switching element is on-off controlled and outputs direct-current voltages of a plurality of kinds of magnitude in accordance with a received command. Examples of the switching elements include a unipolar transistor such as an FET, a bipolar transistor, an IGBT, a thyristor, and a GTO. It should be noted that the type of switching element itself does not limit the present embodiment, and another type of switching element may be employed.

For example, when the power supply 12 is configured to output direct-current voltages of two kinds of magnitude being a high voltage (e.g., 48 V) and a low voltage (e.g., 24 V) in a switchable manner, the high voltage output by the power supply 12 is used as driving voltage of the motor 2 and driving voltage of the servo amplifier control circuit 13 when the motor 2 is driven by the servo amplifier 11. The low voltage output by the power supply 12 is used as driving voltage of the servo amplifier control circuit 13 when the motor 2 is not driven by the servo amplifier 11. It should be noted that switching between the high voltage and the low voltage output by the power supply 12 is performed in conjunction with whether the motor 2 is driven or not. Whether the motor 2 is driven or not may be changed by a manual command operation performed by an operator by using a control operation panel or the like or by a command issued by a motor control unit (unillustrated) in accordance with an operation program of the motor 2. The power supply 12 may be configured to output two or more kinds of magnitude such as 100 V, 48 V, and 24 V. It should be noted that the numerical values cited herein indicating the magnitude of the output voltage of the power supply 12 are strictly examples and may be different values.

The capacitor 18 is connected between a positive-side direct-current power line 19P extending from a positive-side output terminal of the power supply 12 and a negative-side direct-current power line 19N extending from a negative-side output terminal. The capacitor 18 has a function of suppressing a ripple component in the direct-current output of the power supply 12 and a function of accumulating direct-current power. Examples of the capacitor 18 include an electrolytic capacitor and a film capacitor.

The servo amplifier 11 includes an inverter including a bridge circuit based on switching elements. Examples of the switching element include a unipolar transistor such as an FET, a bipolar transistor, an IGBT, a thyristor, and a GTO. It should be noted that the type of switching element itself does not limit the present embodiment, and another type of switching element may be employed. In the example illustrated in FIG. 1, a switching element in a U-phase upper arm is denoted by Su1, and a switching element in a U-phase lower arm is denoted by Su2. A switching element in a V-phase upper arm is denoted by Sv1, and a switching element in a V-phase lower arm is denoted by Sv2. A switching element in a W-phase upper arm is denoted by Sw1, and a switching element in a W-phase lower arm is dented by Sw2. While the switching element being configured with a MOSFET will be described below as an example, the embodiment of the present disclosure is also applicable with an IGBT, a thyristor, a GTO, or a transistor. When the switching element is configured with an IGBT, the embodiment of the present disclosure is applied by reading a “drain” being a current inflow terminal and a “source” being a current outflow terminal as a “collector” and an “emitter,” respectively. When the switching element is configured with a transistor, the embodiment of the present disclosure is applied by reading a “gate” being a control terminal, a “drain” being a current inflow terminal, and a “source” being a current outflow terminal as a “base,” a “collector,” and an “emitter,” respectively. When the switching element is configured with a thyristor or a GTO, the embodiment of the present disclosure is applied by reading a “drain” being a current inflow terminal and a “source” being a current outflow terminal as an “anode” and a “cathode,” respectively.

The servo amplifier 11 performs power conversion between direct-current power and alternating-current power being driving power or regenerative power of the motor 2 by each switching element being on-off driven based on a PWM control method in accordance with a switching command received from the servo amplifier control circuit 13. More specifically, the servo amplifier 11 converts direct-current power supplied from the power supply 12 when the switches 14P and 14N are turned on into alternating-current power at a frequency desired for driving the motor 2 by causing the internal switching elements to perform a switching operation in accordance with a switching command received from the servo amplifier control circuit 13. Thus, for example, the motor 2 operates based on variable-frequency alternating-current power. While regenerative power may be generated when the motor 2 is decelerated, the alternating-current regenerative power generated in the motor 2 is converted into direct-current power and then is returned to the direct current side by causing the internal switching elements to perform the switching operation in accordance with a switching command received from the servo amplifier control circuit 13 in such a case.

The servo amplifier control circuit 13 generates a switching command for on-off control of each switching element and applies the command to the gate terminal of the switching element. The servo amplifier control circuit 13 controls the motor 2 to operate in accordance with a predetermined operation pattern by controlling power conversion by the inverter in the servo amplifier 11 in accordance with a predefined operation program. It should be noted that the configuration of the servo amplifier control circuit 13 defined herein is strictly an example, and, for example, the configuration of the servo amplifier control circuit 13 may be defined with the inclusion of terms such as a position command creation unit, a torque command creation unit, and a switching command creation unit.

Electric power is supplied to the servo amplifier control circuit 13 from the power supply 12 through the positive-side direct-current power line 19P and the negative-side direct-current power line 19N. As described above, the power supply 12 outputs direct-current voltages of at least two kinds of magnitude in a switchable manner. Therefore, direct-current voltages of at least two kinds of magnitude are input to the servo amplifier control circuit 13. On the other hand, the driving voltage of each circuit in the servo amplifier control circuit 13 is always constant regardless of the magnitude of the output voltage of the power supply 12. Then, the servo amplifier control circuit 13 is provided with a voltage conversion circuit configured to convert voltage input from the power supply 12 into driving voltage for driving the servo amplifier control circuit.

For example, when the power supply 12 is configured to output a high voltage of 48 V and a low voltage of 24 V in a switchable manner, either of 48 V and 24 V is input to the servo amplifier control circuit 13. The voltage conversion circuit in the servo amplifier control circuit 13 converts the voltage 48 V or 24 V input from the power supply 12 into driving voltage (e.g., 5 V or 10 V) for driving the servo amplifier control circuit. Examples of the voltage conversion circuit in the servo amplifier control circuit 13 include a step-down chopper circuit, a step-up chopper circuit, a step-up/down chopper circuit, and a circuit including a combination of a switching element and a voltage-dividing resistor.

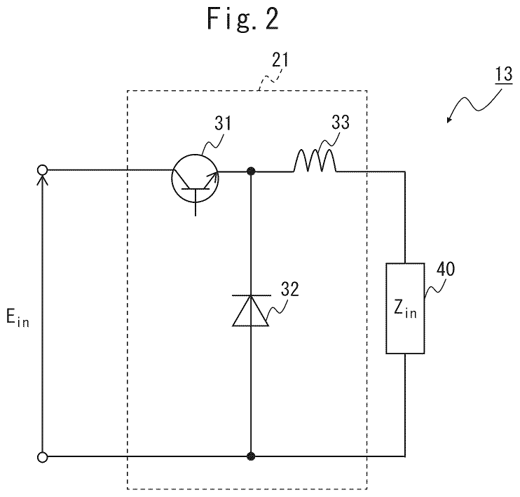

A case of the voltage conversion circuit in the servo amplifier control circuit 13 being configured with a step-down chopper circuit will be described as an example. FIG. 2 is a circuit diagram illustrating a step-down chopper circuit provided in the servo amplifier control circuit in the power supply system according to the embodiment of the present disclosure. As illustrated in FIG. 2, the servo amplifier control circuit 13 is provided with, for example, a step-down chopper circuit including a switching element 31, a diode 32, and an inductor 33 as a voltage conversion circuit 21. Examples of the switching element 31 include a unipolar transistor such as an FET, a bipolar transistor, an IGBT, a thyristor, and a GTO. It should be noted that the type of switching element 31 itself does not limit the present embodiment, and another type of switching element may be employed.

The impedance of a circuit 40 in a stage subsequent to the voltage conversion circuit 21 in the servo amplifier control circuit 13 is denoted by Zᵢₙ in FIG. 2. The input voltage Ein of the voltage conversion circuit 21 is a direct-current voltage of, for example, 48 V or 24 V supplied from the power supply 12. In the voltage conversion circuit 21, energy is stored in the inductor 33 when the switching element 31 is turned on, and energy stored in the inductor 33 is released when the switching element 31 is turned off. The output voltage of the voltage conversion circuit 21 increases as the on-time of the switching element 31 increases, and the output voltage of the voltage conversion circuit 21 decreases as the on-time of the switching element 31 decreases. By controlling the duty ratio of the switching element 31, the output voltage (e.g., 5 V or 10 V) for driving the servo amplifier control circuit is output from the voltage conversion circuit 21.

The description returns to FIG. 1. The positive-side switch 14P and the negative-side switch 14N are provided as switches opening and closing an electric circuit between the power supply 12 and the servo amplifier 11. In other words, the positive-side switch 14P opening and closing an electric circuit between the positive-side direct-current power line 19P extending from the positive-side output terminal of the power supply 12 and the positive-side input terminal of the servo amplifier 11 is provided in the electric circuit. The negative-side switch 14N opening and closing an electric circuit between the negative-side direct-current power line 19N extending from the negative-side output terminal of the power supply 12 and a negative-side input terminal of the servo amplifier 11 is provided in the electric circuit. When receiving an on-command from the switch control circuit 16, the positive-side switch 14P and the negative-side switch 14N perform a closing operation and close the electric circuit between the power supply 12 and the servo amplifier 11. When receiving an off-command from the switch control circuit 16, the positive-side switch 14P and the negative-side switch 14N perform an opening operation and open the electric circuit between the power supply 12 and the servo amplifier 11.

The positive-side potential detection unit 17P detects a positive-side potential of the positive-side direct-current power line 19P extending from the positive-side output terminal of the power supply 12. The negative-side potential detection unit 17N detects a negative-side potential of the negative-side direct-current power line 19N extending from the negative-side output terminal of the power supply 12. The potential difference between the positive-side potential of the positive-side direct-current power line 19P and the negative-side potential of the negative-side direct-current power line 19N is the magnitude of voltage output by the power supply 12. The detection results by the positive-side potential detection unit 17P and the negative-side potential detection unit 17N are sent to the voltage comparison circuit 15.

The voltage comparison circuit 15 compares the voltage output by the power supply 12 with a predefined threshold value. As described above, the power supply 12 outputs direct-current voltages of at least two kinds of magnitude in a switchable manner. The voltage comparison circuit 15 determines the value of the voltage output by the power supply 12 by using the threshold value. The comparison result by the voltage comparison circuit 15 is sent to the switch control circuit 16. For example, when the power supply 12 is configured to output a high voltage of 48 V and a low voltage of 24 V in a switchable manner, either of 48 V and 24 V is output from the power supply 12. In this case, for example, by setting the threshold value to 36 V and comparing the threshold value 36 V with the voltage output by the power supply 12 in the voltage comparison circuit 15, which of 48 V and 24 V is output by the power supply 12 can be determined. In other words, the voltage comparison circuit 15 determines that the power supply 12 outputs the voltage of 24 V when the voltage output by the power supply 12 is equal to or less than the threshold value of 36 V and determines that the power supply 12 outputs the voltage of 48 V when the voltage output by the power supply 12 is greater than the threshold value of 36 V. The numerical value examples described herein are strictly examples and may be different values. It should be noted that the threshold value may be stored in a rewritable storage unit (unillustrated) and be rewritable by external equipment, which allows the threshold value to be changed to a suitable value as necessary even after the value is once set.

The switch control circuit 16 controls opening and closing of the electric circuit between the power supply 12 and the servo amplifier 11 by the positive-side switch 14P and the negative-side switch 14N, based on the comparison result by the voltage comparison circuit 15. A more detailed description is as follows.

When the voltage output by the power supply 12 is determined to be equal to or less than the threshold value by the voltage comparison circuit 15, the switch control circuit 16 transmits an off-command to the positive-side switch 14P and the negative-side switch 14N. The positive-side switch 14P and the negative-side switch 14N receiving the off-command perform the opening operation and open the electric circuit between the power supply 12 and the servo amplifier 11. Since the voltage output by the power supply 12 being determined to be equal to or less than the threshold value corresponds to not driving the motor 2, a low voltage (e.g., 24 V) is output from the power supply 12. Since the positive-side switch 14P and the negative-side switch 14N are in the open state, the voltage output from the power supply 12 is not input to the servo amplifier 11 but, on the other hand, is input to the servo amplifier control circuit 13. Accordingly, since the motor 2 is not driven but the servo amplifier control circuit 13 itself operates, various types of processing including state monitoring processing of the motor 2 can be executed, and safety of the machine is secured.

When the voltage output by the power supply 12 is determined to be greater than the threshold value by the voltage comparison circuit 15, the switch control circuit 16 transmits an on-command to the positive-side switch 14P and the negative-side switch 14N. The positive-side switch 14P and the negative-side switch 14N receiving the on-command operate the closing operation and close the electric circuit between the power supply 12 and the servo amplifier 11. Since the voltage output by the power supply 12 being determined to be greater than the threshold value corresponds to driving the motor 2, a high voltage (e.g., 48 V) is output from the power supply 12. Since the positive-side switch 14P and the negative-side switch 14N are in the closed state, the voltage output from the power supply 12 is input to the servo amplifier 11 and the servo amplifier control circuit 13, and the motor 3 can be driven by the servo amplifier 11.

The voltage comparison circuit 15 described above may include a comparator circuit and, in this case, the switch control unit 16 controls the positive-side switch 14P and the negative-side switch 14N, based on the output of the converter circuit. Alternatively, the voltage comparison circuit 15 described above may include a circuit configuration in which an arithmetic processing device, a memory, and an analog-digital converter are combined.

At least one processor being an arithmetic processing device is provided in the power supply system 1. Examples of the arithmetic processing device include an IC, an LSI, a CPU, an MPU, and a DSP. The arithmetic processing device may include the voltage comparison circuit 15, the switch control circuit 16, the motor control unit (unillustrated), and another processing circuit. For example, each unit included in the arithmetic processing device may be a function module provided by a program executed on a processor. For example, when the voltage comparison circuit 15, the switch control circuit 16, the motor control unit, and the other processing circuit are constructed in a program form, the function of each unit can be provided by operating the arithmetic processing device in accordance with the program. The program for executing each type of processing in the voltage comparison circuit 15, the switch control circuit 16, the motor control unit, and the other processing circuit may be provided in the form of being recorded on a computer-readable recording medium such as a semiconductor memory, a magnetic recording medium, or an optical recording medium. Alternatively, the voltage comparison circuit 15, the switch control circuit 16, the motor control unit, and the other processing circuit may be provided as a semiconductor integrated circuit in which a program providing the function of each unit is written.

At least one memory being a storage device is provided in the power supply system 1. Examples of the memory include an electrically erasable/recordable nonvolatile memory such as an EEPROM (registered trademark) and high-speed readable/writable random-access memories such as a DRAM and an SRAM. For example, the storage device may have a configuration such as an HDD or an SSD. A program for operating the voltage comparison circuit 15, the switch control circuit 16, the motor control unit, and another processing circuit may be stored in the memory. Potential detection results acquired by the positive-side potential detection unit 17P and the negative-side potential detection unit 17N may be stored in the memory. A comparison result by the voltage comparison circuit 15 may be stored in the memory. Various types of data required when the motor is driven may be stored in the memory.

### Operation of Power Supply System According to Embodiment of Present Disclosure

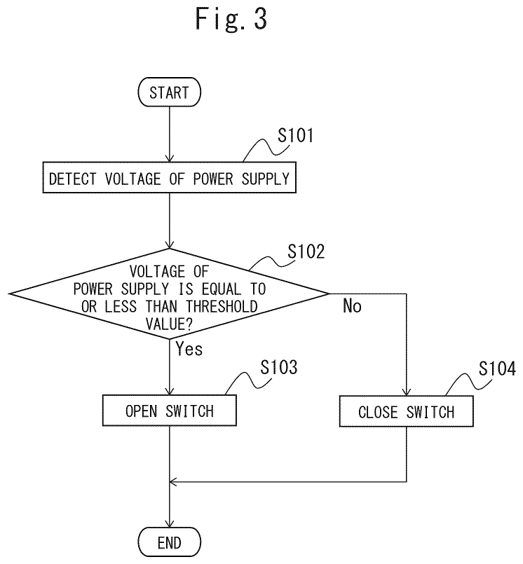

FIG. 3 is a flowchart illustrating an operation related to opening and closing of a switch in the power supply system according to the embodiment of the present disclosure.

The power supply 12 outputs a voltage out of direct-current voltages of at least two kinds of magnitude. In step S101, the positive-side potential detection unit 17P detects the positive-side potential of the positive-side direct-current power line 19P extending from the positive-side output terminal of the power supply 12. The negative-side potential detection unit 17N detects the negative-side potential of the negative-side direct-current power line 19N extending from the negative-side output terminal of the power supply 12. Thus, the magnitude of the voltage output by the power supply 12 is detected. The detection results by the positive-side potential detection unit 17P and the negative-side potential detection unit 17N are sent to the voltage comparison circuit 15.

In step S102, the voltage comparison circuit 15 compares the voltage output by the power supply 12 with the predefined threshold value. When the voltage output by the power supply 12 is determined to be equal to or less than the threshold value by the voltage comparison circuit 15 in step S102, the processing advances to step S103. When the voltage output by the power supply 12 is not determined to be equal to or less than the threshold value (i.e., the voltage output by the power supply 12 is determined to be greater than the threshold value) by the voltage comparison circuit 15 in step S102, the processing advances to step S104.

In step S103, the switch control circuit 16 transmits an off-command to the positive-side switch 14P and the negative-side switch 14N. The positive-side switch 14P and the negative-side switch 14N receiving the off-command perform the opening operation and open the electric circuit between the power supply 12 and the servo amplifier 11. By the positive-side switch 14P and the negative-side switch 14N entering the open state, the voltage output from the power supply 12 is not input to the servo amplifier 11 but, on the other hand, is input to the servo amplifier control circuit 13. Accordingly, since the motor 2 does not operate but the servo amplifier control circuit 13 itself operates, various types of processing including the state monitoring processing of the motor 2 can be executed, and safety of the machine is secured.

In step S104, the switch control circuit 16 transmits an on-command to the positive-side switch 14P and the negative-side switch 14N. The positive-side switch 14P and the negative-side switch 14N receiving the on-command perform the closing operation and close the electric circuit between the power supply 12 and the servo amplifier 11. Since the positive-side switch 14P and the negative-side switch 14N enter the closed state, the voltage output from the power supply 12 is input to the servo amplifier 11 and the servo amplifier control circuit 13, and the motor 3 can be driven by the servo amplifier 11.

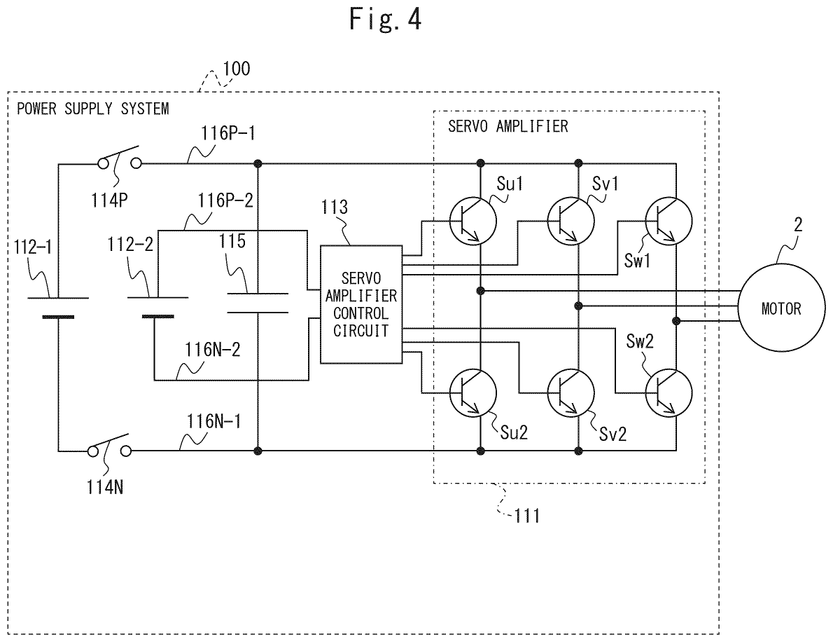

FIG. 4 is a circuit diagram illustrating a power supply system based on a conventional example in which a drive power supply and a control power supply are separately provided.

In a power supply system 100 based on the conventional example in which a drive power supply 112-1 and a control power supply 112-2 are separately provided, a positive-side power switch 114P and a negative-side power switch 114N are provided on the output side of the drive power supply 112-1 in order to prevent supply of electric power from the drive power supply 112-1 to a servo amplifier 111 when a motor 2 is not driven. The positive-side power switch 114P is connected to a positive-side input terminal of the servo amplifier 111 through a positive-side drive power line 116P-1. The negative-side power switch 114N is connected to a negative-side input terminal of the servo amplifier 111 through a negative-side drive power line 116N-1. The positive-side terminal and the negative-side terminal of the control power supply 112-2 are connected to the servo amplifier control circuit 113 through a positive-side control power line 116P-2 and a negative-side control power line 116N-2, respectively. Thus, according to the conventional example, a total of four power lines being the positive-side drive power line 116P-1, the negative-side drive power line 116N-1, the positive-side control power line 116P-2, and the negative-side control power line 116N-2 are required between the drive power supply 112-1 and the control power supply 112-2, and the servo amplifier 111 and the servo amplifier control circuit 113.

On the other hand, according to the embodiment of the present disclosure, only a total of two power lines being the positive-side direct-current power line 19P and the negative-side direct-current power line 19N suffice for the connection between the power supply 12, and the servo amplifier 11 and the servo amplifier control circuit 13, as illustrated in FIG. 1. Therefore, the embodiment of the present disclosure can achieve reduction in power wiring in addition to securing safety of the machine when the motor 2 is driven and stopped. For example, the effect of reduction in power wiring increases when the servo amplifiers 11 are placed close to the motor 2 in an industrial robot and the servo amplifiers 11 are daisy-chained.

While the present disclosure has been described in detail above, the present disclosure is not limited to each embodiment described above. Various additions, substitutions, changes, partial deletions, and the like may be made to the embodiments without departing from the spirit of the present disclosure or without departing from the scope of the present disclosure derived from the contents described in the claims and the equivalents thereof. Further, the embodiments may be implemented in combination. For example, the operation order or processing order is described as an example in the aforementioned embodiments and is not limited thereto. Further, the above also holds when a numerical value or a mathematical expression is used in the description of the aforementioned embodiments.

### SUPPLEMENTARY NOTES

The following Supplementary Notes are further disclosed with regard to the aforementioned embodiments and the modified examples thereof.

### Supplementary Note 1

A power supply system including:
a servo amplifier 11;
a power supply 12 configured to output voltages of at least two kinds of magnitude in a switchable manner;
a servo amplifier control circuit 13 being connected to the power supply 12 and configured to control the servo amplifier 11;
switches 14P and 14N configured to open and close an electric circuit between the power supply 12 and the servo amplifier 11;
a voltage comparison circuit 15 configured to compare voltage output by the power supply 12 with a predefined threshold value; and
a switch control circuit 16 controlling opening and closing of an electric circuit between the power supply 12 and the servo amplifier 11 by the switches 14P and 14N, based on a comparison result by the voltage comparison circuit 15.

### Supplementary Note 2

The power supply system according to Supplementary Note 1, wherein
the switch control circuit 16 configured to control the switches 14P and 14N in such a way as to open an electric circuit between the power supply 12 and the servo amplifier 11 when voltage output by the power supply 12 is determined to be equal to or less than the threshold value by the voltage comparison circuit 15 and controls the switches 14P and 14N in such a way as to close an electric circuit between the power supply 12 and the servo amplifier 11 when voltage output by the power supply 12 is determined to be greater than the threshold value by the voltage comparison circuit 15.

### Supplementary Note 3

The power supply system according to Supplementary Note 1 or 2, wherein
the servo amplifier control circuit 13 includes a voltage conversion circuit 21 configured to convert voltage input from the power supply 12 into driving voltage for driving the servo amplifier control circuit 13.

### REFERENCE SIGNS LIST

1 Power supply system
2 Motor
11 Servo amplifier
12 Power supply
13 Servo amplifier control circuit
14P Positive-side switch
14N Negative-side switch
15 Voltage comparison circuit
16 Switch control circuit
17P Positive-side potential detection unit
17N Negative-side potential detection unit
18 Capacitor
19P Positive-side direct-current power line
19N Negative-side direct-current power line
21 Voltage conversion circuit
31 Switching element
32 Diode
33 Inductor
Su1, Su2, Sv1, Sv2, Sw1, Sw2 Switching element

1. A power supply system comprising:
a servo amplifier;
a power supply configured to output voltages of at least two kinds of magnitude in a switchable manner;
a servo amplifier control circuit being connected to the power supply and configured to control the servo amplifier;
switches configured to open and close an electric circuit between the power supply and the servo amplifier;
a voltage comparison circuit configured to compare voltage output by the power supply with a predefined threshold value; and
a switch control circuit configured to control opening and closing of an electric circuit between the power supply and the servo amplifier by the switches, based on a comparison result by the voltage comparison circuit.

2. The power supply system according to claim 1, wherein
the switch control circuit controls the switches in such a way as to open an electric circuit between the power supply and the servo amplifier when voltage output by the power supply is determined to be equal to or less than the threshold value by the voltage comparison circuit and controls the switches in such a way as to close an electric circuit between the power supply and the servo amplifier when voltage output by the power supply is determined to be greater than the threshold value by the voltage comparison circuit.

3. The power supply system according to claim 1, wherein
the servo amplifier control circuit includes a voltage conversion circuit configured to convert voltage input from the power supply into driving voltage for driving the servo amplifier control circuit.
